(19) United States
(12) Patent Application Publication
(10) Pub. No.: US 2026/0065645 A1
(43) Pub. Date: Mar. 5, 2026

(54) IMAGE CLASSIFICATION APPARATUS, IMAGE CLASSIFICATION METHOD, AND COMPUTER-READABLE, NON-TRANSITORY RECORDING MEDIUM STORING IMAGE CLASSIFICATION PROGRAM

(71) Applicant: JVCKENWOOD Corporation, Yokohama-shi, Kanagawa (JP)

(72) Inventor: Hideki TAKEHARA, Yokohama-shi (JP)

(21) Appl. No.: 19/314,462

(22) Filed: Aug. 29, 2025

(30) Foreign Application Priority Data
Sep. 3, 2024 (JP) 2024-151547

(51) Int. Cl. G06V 10/764; G06V 10/776

(52) U.S. Cl. CPC G06V 10/764; G06V 10/776

(57) ABSTRACT

In an image classification apparatus adapted to classify an input image, an image classification model calculates a prediction vector predicting a class into which the input image is classified. A confidence level evaluation unit calculates a probability vector and a confidence level of classification, based on the prediction vector for the input image. An image conversion unit converts the input image to generate a converted image when the confidence level is less than a first threshold value. An integrated evaluation unit calculates an integrated prediction vector derived from adding up the prediction vector for the input image and a prediction vector for the converted image calculated based on the image classification model and calculates an integrated probability vector from the integrated prediction vector. A classification determination unit determines a class of the input image based on the probability vector or the integrated probability vector.

### CROSS REFERENCE TO RELATED APPLICATION

This application claims the benefit of priority from the prior Japanese Patent Application No. 2024-151547, filed on Sep. 3, 2024, the entire content of which is incorporated herein by reference.

### BACKGROUND

### 1. Technical Field

The present disclosure relates to an image classification technology.

### 2. Description of the Related Art

Ensemble learning is available as a generally known learning method in the field of machine learning (for example, Patent Literature 1). Ensemble learning is a learning method in which multiple inference engines are trained on one piece of data, and the results of multiple inference engines are added up at the time of inference to obtain an ultimate inference result by majority vote, etc. This represents an idea of adding up evaluations of multiple inferences on one piece of data to obtain an ultimate evaluation.

Further, a technology called data augmentation for increasing data is available as a technology used for machine learning and is used to expand the amount of training data (for example, Patent Literature 2).
[Patent Literature 1] JP2023-117246
[Patent Literature 2] JP2021-36969

It is known that recent deep learning models inductively trained by using large-scale training data are sufficiently accurate even in the case of a single deep learning model. However, recursively trained deep learning models contain black box characteristics, and the causal relationship between the input image and the inference result has not been fully elucidated. Therefore, it is known that a recursively trained deep learning model, when operated in the real world, is not sufficiently accurate for images with characteristics different from those of the learned images.

### SUMMARY

An image classification apparatus according to an embodiment of the present disclosure is an image classification apparatus adapted to classify an input image, including: an image classification model that calculates a prediction vector predicting a class into which the input image is classified; a confidence level evaluation unit that calculates a probability vector and a confidence level of classification, based on the prediction vector for the input image; an image conversion unit that converts the input image to generate a converted image when the confidence level is less than a first threshold value; an integrated evaluation unit that calculates an integrated prediction vector derived from adding up the prediction vector for the input image and a prediction vector for the converted image calculated based on the image classification model and calculates an integrated probability vector from the integrated prediction vector; and a classification determination unit that determines a class of the input image based on the probability vector or the integrated probability vector.

Another embodiment of the present disclosure relates to an image classification method. The method is an image classification method adapted to classify an input image, including: calculating, by using an image classification model, a prediction vector predicting a class into which the input image is classified; calculating a probability vector and a confidence level of classification, based on the prediction vector for the input image; converting the input image to generate a converted image when the confidence level is less than a first threshold value; calculating an integrated prediction vector derived from adding up the prediction vector for the input image and a prediction vector for the converted image calculated based on the image classification model, and calculating an integrated probability vector from the integrated prediction vector; and determining a class of the input image based on the probability vector or the integrated probability vector.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

The disclosure will be described with reference to the following drawings.

FIG. 1 shows a configuration of an image classification apparatus according to the embodiment;

FIG. 2 shows a configuration of the image classification model of FIG. 1;

FIG. 3 is a flowchart showing the steps of classification of the input image performed by the image classification apparatus;

FIG. 4 is a flowchart showing a variation of the steps of classification of the input image performed by the image classification apparatus;

FIG. 5 shows classification by the image classification model of FIG. 1;

FIGS. 6A-6C show the values of each component of the probability vectors of the images P, Q, and R;

FIG. 7 shows another method for deriving the confidence level of image classification; and

FIGS. 8A-8E show the manner of clipping in the conversion process.

### DETAILED DESCRIPTION

The invention will now be described by reference to the preferred embodiments. This does not intend to limit the scope of the present invention, but to exemplify the invention.

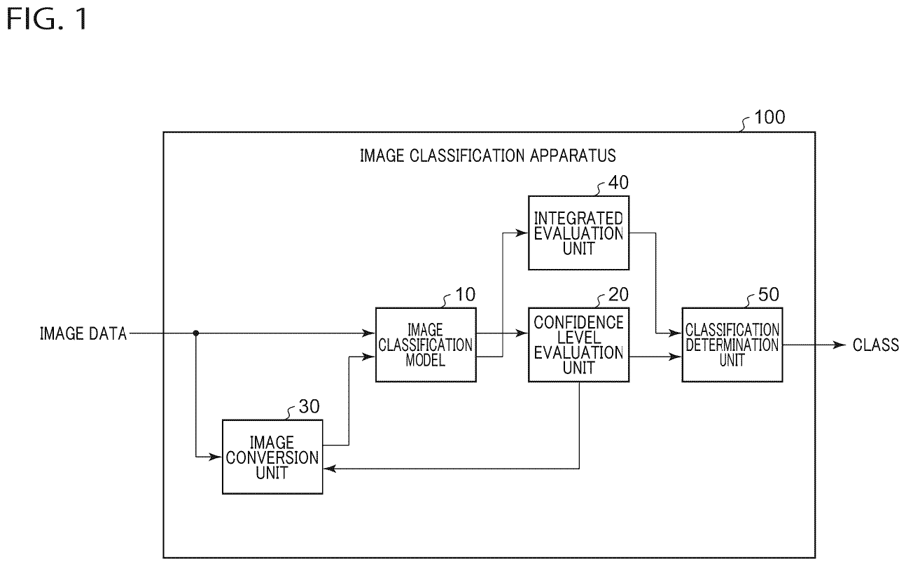

FIG. 1 shows a configuration of an image classification apparatus 100 according to the embodiment. The image classification apparatus 100 receives image data and outputs a class of the image. The image classification apparatus 100 includes an image classification model 10, a confidence level evaluation unit 20, an image conversion unit 30, an integrated evaluation unit 40, and a classification determination unit 50.

The image classification model 10 calculates a prediction vector in response to an input image and outputs the prediction vector for the input image to the confidence level evaluation unit 20 and the integrated evaluation unit 40. The image classification model 10 has been trained to learn classes in image classification in advance by machine learning. Each component of the prediction vector is a logit (predicted value) for each class into which the image is classified. In this example, the image classification model 10 has been trained for classification into L classes. For example, L=200 but L may be an integer value equal to or greater than 2 and is not limited thereto.

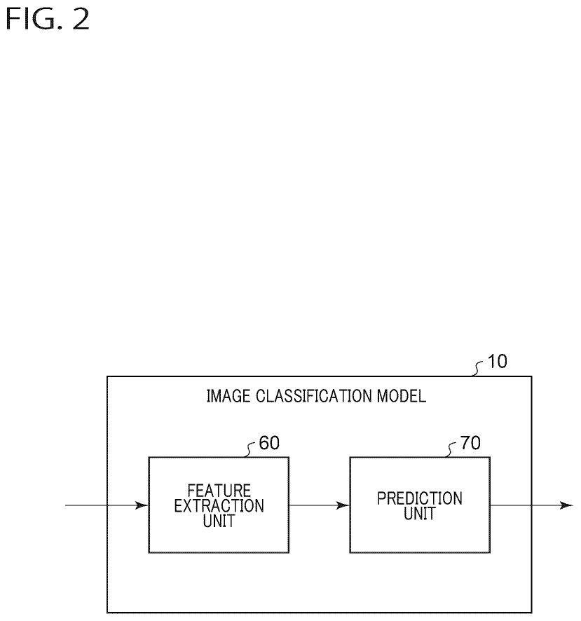

FIG. 2 shows a configuration of the image classification model 10. The image classification model 10 includes a feature extraction unit 60 and a prediction unit 70.

The image classification model 10 is a deep neural network by way of one example, and, in this example, is assumed to be ResNet-50. The image classification model 10 is not limited to ResNet-50 and may be a deep neural network using a CNN such as ResNet-18, ResNet-101, and ResNet-50×4 or a deep neural network using a ViT (Vision Transformer) transformer. The image classification model 10 is assumed to have been trained on a large-scale training dataset in advance.

When image data is input, the feature extraction unit 60 outputs an M-dimensional feature vector indicating the feature quantity of the image. For example, M=2048.

When the feature vector is input, the prediction unit 70 outputs an L-dimensional prediction vector indicating the predicted value predicting the class.

Reference is made back to FIG. 1. The confidence level evaluation unit 20 calculates an L-dimensional probability vector by multiplying the L-dimensional prediction vector by a softmax function that is an activating function. The confidence level evaluation unit 20 derives the confidence level of classification based on the L-dimensional probability vector. The value of the i-th component (i=1−L) of the L-dimensional probability vector is the probability of classification into class i. The confidence level evaluation unit 20 derives the highest probability value of the components of the probability vector as the confidence level of classification.

When the confidence level of classification is equal to or greater than a reference value, the confidence level evaluation unit 20 outputs the L-dimensional probability vector to the classification determination unit 50. Details of the confidence level and the reference value will be described later.

The classification determination unit 50 determines the classification of the input image based on the L-dimensional probability vector. The input image is classified into a class corresponding to the component having the highest probability among the components of the L-dimensional probability vector on an assumption that the confidence level of classification is sufficiently high.

When the confidence level of classification is less than the reference value, the confidence level evaluation unit 20 instructs the image conversion unit 30 to generate a converted image from the input image. The confidence level evaluation unit 20 sets the number of converted images N according to the confidence level of classification and instructs the image conversion unit 30 accordingly. Details of the number of converted images N according to the confidence level of classification will be described later.

The image conversion unit 30 performs an image conversion process on the input image to generate N converted images. The image conversion unit 30 outputs the N converted images thus generated to the image classification model 10. The image conversion process is exemplified by clipping, rotation, etc. of the image, and details thereof will be described later.

The image classification model 10 calculates a prediction vector for each of the N converted images. The image classification model 10 outputs the prediction vectors for the N converted images to the integrated evaluation unit 40.

The integrated evaluation unit 40 calculates an integrated prediction vector by adding up the prediction vector for the input image and the prediction vectors for the N converted images. The integrated evaluation unit 40 calculates an integrated probability vector by multiplying the integrated prediction vector by a softmax function that is an activating function. The integrated evaluation unit 40 outputs the integrated probability vector to the classification determination unit 50.

More specifically, the integrated evaluation unit 40 calculates the prediction vector PVn (n=1, 2, . . . , N) for each of the N converted images. Denoting the prediction vector for the input image by PV0, the integrated evaluation unit 40 calculates the integrated prediction vector PVa as given by the following expression, by adding up the prediction vector for the input image and the prediction vectors for the converted images.

$$PVa = {\sum }_{n = 0}^{N} PVn$$

The integrated evaluation unit 40 calculates the integrated probability vector from the integrated prediction vector PVa and supplies the vector to the classification determination unit 50.

The classification determination unit 50 determines the classification of the input image based on the integrated probability vector. The input image is classified into a class corresponding to the component having the highest probability among the components of the L-dimensional integrated probability vector.

Thus, the input image can be evaluated from multiple perspectives by inputting a plurality of converted images in addition to the input image to one image classification model 10 and considering the probability distributions based on the features of the plurality of converted images in addition to the input image. By using the confidence level evaluated from multiple perspectives, the reliability of image classification is improved. By clipping a part of the image to evaluate the feature of the detail of the image, in particular, it is possible to improve the reliability of the determination on an image at a boundary of classification in the feature space.

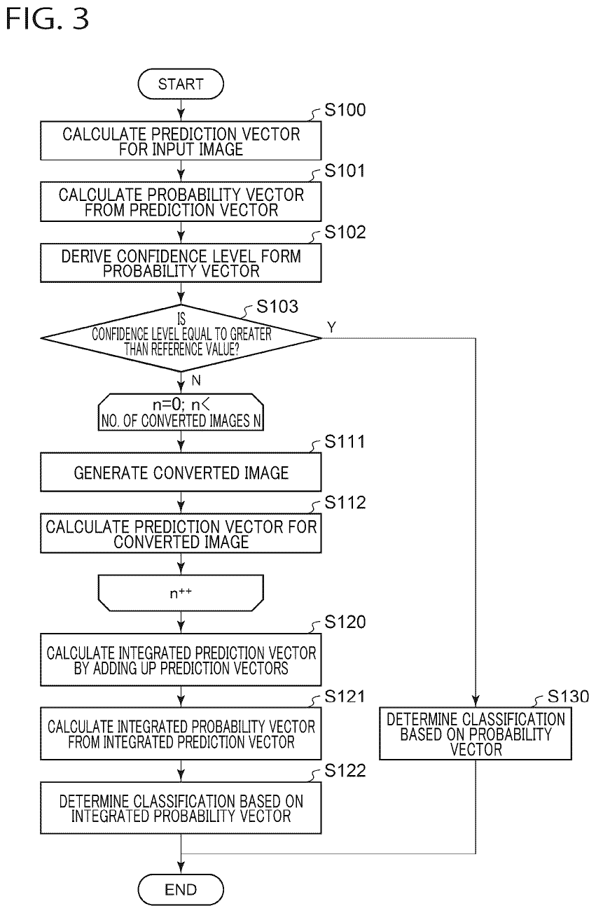

FIG. 3 is a flowchart showing the steps of classification of the input image performed by the image classification apparatus 100.

The image classification model 10 calculates the prediction vector for the input image (S100). The confidence level evaluation unit 20 calculates the probability vector from the prediction vector (S101). The confidence level evaluation unit 20 derives the confidence level from the probability vector (S102).

The confidence level evaluation unit 20 confirms whether the confidence level is equal to or greater than the reference value (S103). When the confidence level is equal to or greater than the reference value (Y in S103), the classification determination unit 50 determines the classification based on the probability vector (S130).

When the confidence level is less than the reference value (N in S103), the confidence level evaluation unit 20 sets the number of converted images N according to the conviction level and instructs the image conversion unit 30 to generate the converted image.

The process from step S111 through step S112 is repeated N times. The image conversion unit 30 performs an image conversion process on the input image to generate the conversion image (S111). The image classification model 10 calculates the prediction vector for the converted image (S112).

The integrated evaluation unit 40 calculates the integrated prediction vector by adding up the prediction vector for the input image and the prediction vectors for the N converted images (S120). The integrated evaluation unit 40 calculates the integrated probability vector from the integrated prediction vector (S121). The classification determination unit 50 determines the classification based on the integrated probability vector (S122).

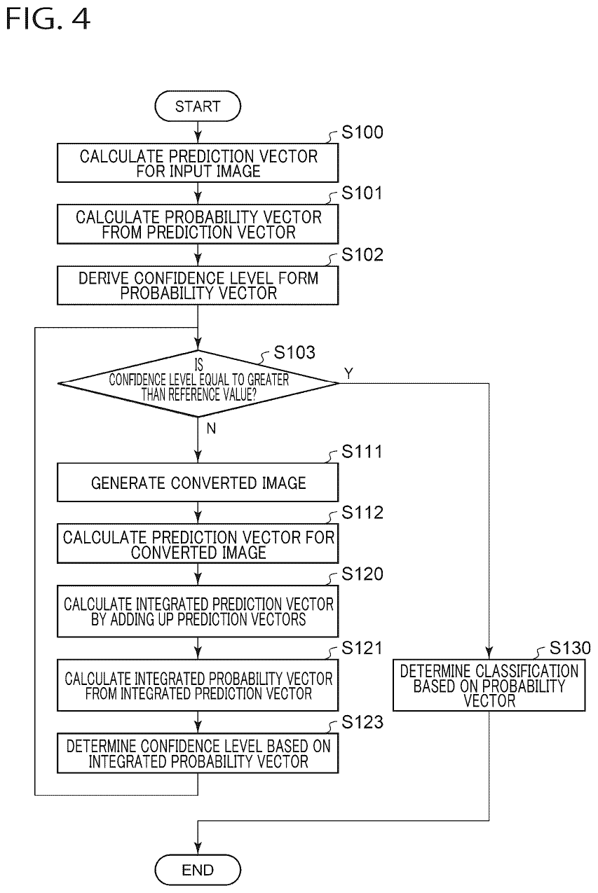

FIG. 4 is a flowchart showing a variation of the steps of classification of the input image performed by the image classification apparatus 100. In the classification steps of FIG. 3, the number of converted images N is set, N converted images are generated, and the prediction vector for the input image and the prediction vectors for N converted images are added to calculate the integrated prediction vector. In the variation of the classification steps of FIG. 4, a pattern for generating the converted image is determined in advance, the conversion image is created one by one, and the prediction vector for the converted image is added each time to calculate the integrated prediction vector, and the confidence level is derived from the integrated prediction vector. The generation of the converted image is repeated until the confidence level is equal to or greater than the reference value. When the confidence level reaches the reference value, the generation of the converted image is interrupted, and the classification is determined based on the integrated prediction vector at that point of time.

The image classification model 10 calculates the prediction vector for the input image (S100). The confidence level evaluation unit 20 calculates the probability vector from the prediction vector (S101). The confidence level evaluation unit 20 derives the confidence level from the probability vector (S102).

The confidence level evaluation unit 20 confirms whether the confidence level is equal to or greater than the reference value (S103). When the confidence level is equal to or greater than the reference value (Y in S103), the classification determination unit 50 determines the classification based on the probability vector (S130).

When the confidence level is less than the reference value (N in S103), the confidence level evaluation unit 20 instructs the image conversion unit 30 to generate one converted image.

The image conversion unit 30 performs an image conversion process on the input image to generate the conversion image (S111). The image classification model 10 calculates the prediction vector for the converted image (S112).

The integrated evaluation unit 40 calculates the integrated prediction vector by adding up the prediction vectors for the converted images (S120). More specifically, the prediction vector for the first converted image is initially added to the prediction vector for the input image. For the second and subsequent converted images, the prediction vectors for the second and subsequent converted images are sequentially added to the integrated prediction vector calculated so far to calculate the integrated prediction vector.

The integrated evaluation unit 40 calculates the integrated probability vector from the integrated prediction vector (S121). The integrated evaluation unit 40 derives the confidence level from the integrated probability vector (S123).

Returning to step S103, the integrated evaluation unit 40 confirms whether the confidence level is equal to or greater than the reference value (S103). When the confidence level is equal to or greater than the reference value (Y in S103), the classification determination unit 50 determines the classification based on the probability vector (S130). When the confidence level is less than the reference value (N in S103), steps S111-S123 are executed again, the next converted image is generated, and the prediction vector for the converted image is added to calculate the integrated prediction vector to derive the confidence level.

The variation of the classification steps of FIG. 4 differs from the classification steps of FIG. 3 in that the converted images are sequentially generated in the order of priority in the predetermined pattern for generating the converted image, and the prediction vector for each converted image is sequentially added to the integrated prediction vector, and the confidence level is evaluated. The prediction vector for the converted image having a high priority is sequentially added to calculate the integrated prediction vector, and the subsequent conversion process is terminated when the confidence level derived from the integrated prediction vector reaches the reference value. This makes it possible to omit the process of calculating the prediction vector for the conversion image having a low priority reduce and the overall processing volume. Further, while the converted image having a low priority may cause a decrease in the accuracy of the integrated prediction vector, the accuracy of the integrated prediction vector can be prevented from decreasing by adopting the classification steps of FIG. 4.

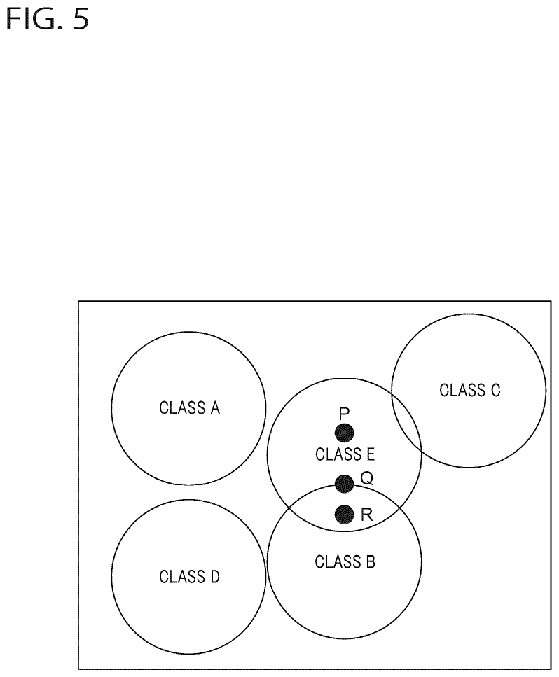

FIG. 5 shows classification by the image classification model 10. The feature extraction unit 60 of the image classification model 10 converts a two-dimensional input image into an M-dimensional feature vector. In the case M=2024, this is equivalent to mapping the two-dimensional input image to a 2048-dimensional feature space.

FIG. 5 is a conceptual diagram of the M-dimensional feature space and schematically two-dimensionally shows how five classes from class A to class E are mapped to the feature space. The feature extraction unit 60 is trained in advance by the training data so that the image of each class is mapped inside the circle of each class.

The positions of the feature vectors of the images P, Q, and R of class E are shown as points P, Q, and R in the feature space. The image P is a typical image of class E, and the point P is located near the center of the circle presented by class E. The image Q is an image of class E but is also slightly similar to class B, and the point Q is at a position within class E near the boundary of class B. The image R is an image of class E but is also similar to class B, and the point R is at a position in a region where class E and class B overlap.

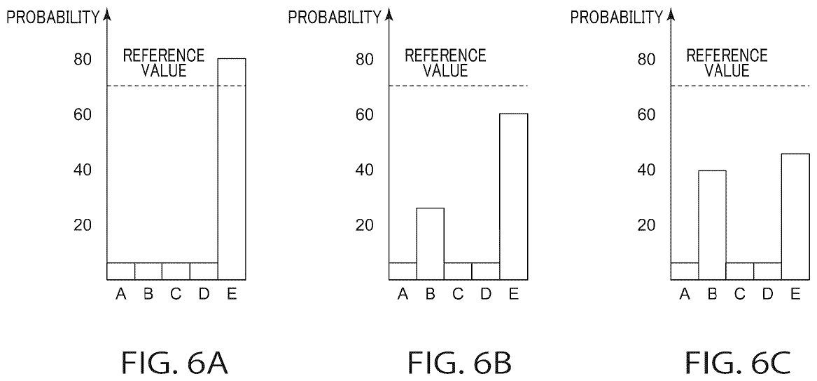

FIGS. 6A-6C show the values of the respective components of the probability vectors of the images P, Q, and R. Each component of the probability vector indicates the probability of each of classes A-E. FIGS. 6A, 6B, and 6C graphically show the values of the respective components of the probability vectors for the images P, Q, and R, respectively. The vertical axis represents the probability, the horizontal axis represents the class, and the dashed line indicates the reference value.

In the case of the probability vector for the image P, the probability of class E is sufficiently large and exceeds the reference value, while the probability of the other classes A-D is sufficiently small.

In the case of the probability vector for the image Q, the probability of class E is the largest but is below the reference value, and the probability of class B is also somewhat larger.

In the case of the probability vector for the image R, the probability of both class E and class B is large, and the difference between the two is small.

In other words, when the probability of class E is sufficiently large as in the case of the image P, it is easy to determine that the image P is classified into class E. When the probability of class E is not sufficiently large as in the case of the image Q and the image R, it is not easy to determine that the image Q or the image R is classified into class E.

The highest probability value of the components of the probability vector is derived as the confidence level. In this example, the highest probability value of the components of the probability vector is the probability of class E in each of the cases of the images P, Q, and R, and so the confidence level is the value of the probability of class E. The reference value is, for example, 0.75 but is not limited to this value. In the following description, it is assumed that the confidence level is, for convenience, represented by a numeral 0-100, which is the probability value 0-1 multiplied by 100, and that the reference value is 75.

In the case of the image P, the probability of class E, which is highest among the components of the probability vector of FIG. 6A, i.e., the confidence level, is equal to or greater than the reference value so that the confidence level evaluation unit 20 supplies the probability vector for the image P to the classification determination unit 50. The classification determination unit 50 determines classifying the image P into class E corresponding to the component having the largest probability among the components of the probability vector for the image P.

In the case of the image Q and the image R, the probability of class E, which is highest among the components of the probability vector of FIGS. 6B and 6C, i.e., confidence level, does not exceed the reference value so that classification is not determined immediately, and the confidence level evaluation unit 20 instructs the image conversion unit 30 to generate N converted images for the image Q and the image R.

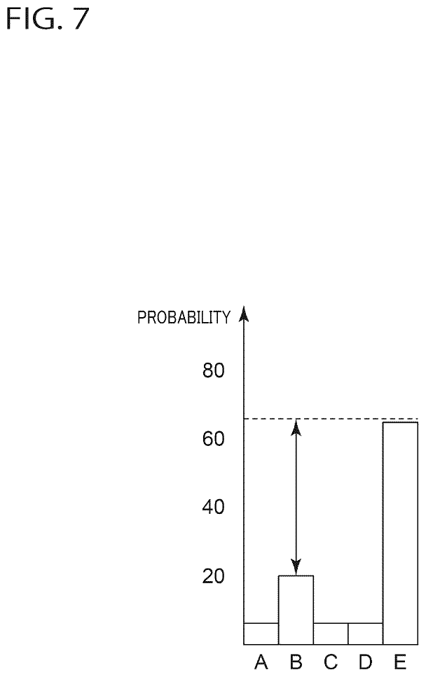

FIG. 7 shows another method for deriving the confidence level of image classification. In one variation of the confidence level, the difference between the highest probability value and the second highest probability value in the probability vector may be derived as the confidence level.

The confidence level evaluation unit 20 determines, by way of one example, the number of converted images N as shown in Table 1 according to the confidence level of image classification. The higher the confidence level, the smaller the number of converted images N, and the lower the confidence level, the larger the number of converted images N. In the case the confidence level is too low, however, the number of converted image N is set to 0, and image conversion is not processed because the noise increases if the converted image is generated.

TABLE 1

| Confidence level | Number of converted images N |
|---|---|
| less than 25 | 0 |
| equal to or greater than 25 | 5 |
| and less than 50 | |
| equal to or greater than 50 | 3 |
| and less than 75 | |
| equal to or greater than 75 | 0 |

In the example of Table 1, the confidence level of the image Q is 60 so that the number of converted images N is 3, and the confidence level of the image R is 45 so that the number of converted images N is 5.

In the case of Table 1, the converted image is not generated so that the components of the integrated prediction vector will all be 0 in the case the confidence level is less than 25. Therefore, the classification result cannot be obtained, and classification is not possible. In one variation, the conversion image may not be generated, but the classification may be determined based on the probability vector for the input image, in the case the confidence level is less than 25. Defining the reference value described so far as the first reference value (in this case, 75), a second reference value (smaller than the first reference value; in this case, 25) is newly provided. Instead of step S103 in FIG. 3, the confidence level evaluation unit 20 confirms whether the confidence level is equal to or greater than the first reference value or whether the confidence level is less than the second reference value (S103′). When the confidence level is equal to or greater than the first reference value or the confidence level is less than the second reference value (Y in S103′), the confidence level evaluation unit 20 outputs the probability vector for the input image to the classification determination unit. When the confidence level is equal to or greater than the second reference value and less than the first reference value (N in S103′), the confidence level evaluation unit 20 instructs the image conversion unit 30 to generate the converted image.

Further, when the confidence level is too low, the number converted images N may not be set to 0. Instead, as shown in Table 2, the number of converted images may be set to be small when the confidence level is less than the second reference value.

TABLE 2

| Confidence level | Number of converted images N |
|---|---|
| less than 25 | 2 |
| equal to or greater than 25 | 6 |
| and less than 50 | |
| equal to or greater than 50 | 4 |
| and less than 75 | |
| equal to or greater than 75 | 0 |

Yet another method of setting the number of converted images N will be explained. As shown in Table 3, the higher the confidence level, the smaller the number of converted images N, and the lower the confidence level, the larger the number of converted images N, when the confidence level is equal to or greater than a predetermined threshold value (in this case, 45). When the confidence level is less than a predetermined threshold value (in this case, 45), the higher the confidence level, the larger the number of converted images N, and the lower the confidence level, the smaller the number of converted images N. Thus, the amount of information available for classification can be increased by ensuring that the lower the confidence level, the larger the number of converted images in the case the confidence level is equal to or greater than a predetermined threshold value. Meanwhile, the S/N ratio can be increased by ensuring that the lower the confidence level, the smaller the number of converted images in the case the confidence level is less than a predetermined threshold value to prevent the noise from increasing.

TABLE 3

| Confidence level | Number of converted images N |
|---|---|
| less than 25 | 0 |
| equal to or greater than 25 | 1 |
| and less than 35 | |
| equal to or greater than 35 | 3 |
| and less than 45 | |
| equal to or greater than 45 | 5 |
| and less than 55 | |
| equal to or greater than 55 | 3 |
| and less than 65 | |
| equal to or greater than 65 | 1 |
| and less than 75 | |
| equal to or greater than 75 | 0 |

The conversion process on the input image is predetermined. By way of one example, the conversion process is defined in the order of the type of converted image as shown in Table 4. The smaller the number for the type of converted image, the higher the priority. In the case the number of converted images N is 3, three converted images are generated by the conversion process corresponding to the types 1-3 of converted image. In the case the number of converted images N is 5, five converted images are generated by the conversion process corresponding to the types 1-5 of converted image.

TABLE 4

| Type of converted image | Conversion process |
|---|---|
| 1 | clip the center of the image |
| | to reduce the horizontal and |
| | vertical sizes to ¾ |
| 2 | clip the top left of the |
| | image to reduce the |
| | horizontal and vertical |
| | sizes to ¾ |
| 3 | clip the top right of the |
| | image to reduce the |
| | horizontal and vertical |
| | sizes to ¾ |
| 4 | clip the bottom left of the |
| | image to reduce the |
| | horizontal and vertical |
| | sizes to ¾ |
| 5 | clip the bottom right of the |
| | image to reduce the |
| | horizontal and vertical |
| | sizes to ¾ |

In the example of Table 4, the correspondence between the type of converted image and the conversion process is as follows.

Type of converted image 1: clip the center of the image to reduce the horizontal and vertical sizes to 3/4.

Type of converted image 2: clip the top left of the image to reduce the horizontal and vertical sizes to 3/4.

Type of converted image 3: clip the top right of the image to reduce the horizontal and vertical sizes to 3/4.

Type of converted image 4: clip the bottom left of the image to reduce the horizontal and vertical sizes to 3/4.

Type of converted image 5: clip the bottom right of the image to reduce the horizontal and vertical sizes to 3/4.

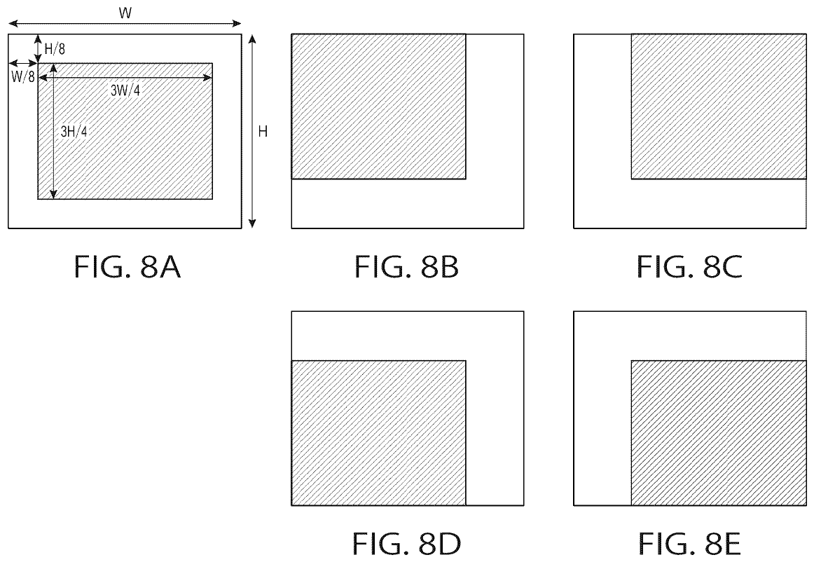

FIGS. 8A-8E show the manner of clipping in the conversion process. All are examples of clipping the input image having a vertical size H and a horizontal size W to 3/4vertically and horizontally to generate a clipped image (indicated by diagonal lines) having a vertical size 3H/4 and a horizontal size 3W/4. FIG. 8A shows that the center of the image is clipped, FIG. 8B shows that the upper left of the image is clipped, FIG. 8C shows that the upper right of the image is clipped, FIG. 8D shows that the lower left of the image is clipped, and FIG. 8E shows that the lower right of the image is clipped. The size and position of clipping is not limited to this. A region of interest (ROI: Region of interest) may be extracted and clipped.

In an image conversion process, image rotation may be performed in addition to clipping the image, as shown in Table 5. Further, vertical or horizontal flipping may be performed. The priority is in the order of clipping, vertical flipping, rotation (rotation of 15 degrees, 30 degrees, 45 degrees, 60 degrees, 90 degrees, etc. is conceivable, but it is desirable that the rotation angle is not too large), horizontal flipping, and a combination thereof. Vertical flipping is equivalent to vertical reversing, and horizontal flipping is equivalent to horizontal reversing.

TABLE 5

| Type of converted image | Conversion process |
|---|---|
| 1 | clip the center of the image |
| | to reduce the horizontal and |
| | vertical sizes to ¾ |
| 2 | clip the top left of the image to |
| | reduce the horizontal and vertical |
| | sizes to ¾ |
| 3 | clip the top right of the |
| | image to reduce the |
| | horizontal and vertical |
| | sizes to ¾ |
| 4 | clip the bottom left of the |
| | image to reduce the |
| | horizontal and vertical |
| | sizes to ¾ |
| 5 | clip the bottom right of the image to |
| | reduce the horizontal and vertical |
| | sizes to ¾ |
| 6 | flip the image vertically |
| 7 | rotate the image 15 degrees |
| | rightward |
| 8 | rotate the image 15 degrees |
| | leftward |
| 9 | clip the center of the image |
| | to reduce the horizontal and |
| | vertical sizes to ¾ |
| | and rotate the image 45 degrees |
| | rightward |
| 10 | clip the center of the image to |
| | reduce the horizontal and |
| | vertical sizes to ¾ |
| | and rotate the image 45 degrees |
| | leftward |

In the example in Table 5, the correspondence between the type of converted image and the conversion process is as follows.

Type of converted image 1: clip the center of the image to reduce the horizontal and vertical sizes to 3/4.

Type of converted image 2: clip the top left of the image to reduce the horizontal and vertical sizes to 3/4.

Type of converted image 3: clip the top right of the image to reduce the horizontal and vertical sizes to 3/4.

Type of converted image 4: clip the bottom left of the image to reduce the horizontal and vertical sizes to 3/4.

Type of converted image 5: clip the bottom right of the image to reduce the horizontal and vertical sizes to 3/4.

Type of converted image 6: flip the image vertically.

Type of converted image 7: rotate the image 15 degrees clockwise.

Type of converted image 8: rotate the image 15 degrees counterclockwise.

Type of converted image 9: clip the center of the image to reduce the horizontal and vertical sizes to 3/4 and rotate the image 45 degrees clockwise.

Type of converted image 10: clip the center of the image to reduce the horizontal and vertical sizes to 3/4, and the image is rotated 45 degrees counterclockwise.

As described above, the image classification apparatus 100 of the embodiment can achieve improvement in accuracy even in images having characteristics different from those of images learned in the real world, by using a highly accurate, recursively trained deep learning model to obtain an ultimate evaluation result derived from evaluating input data by a single deep learning model in multiple perspectives and aggregating the evaluation.

The above-described various processes in the image classification apparatus 100 can of course be implemented by hardware-based apparatuses such as a CPU and a memory and can also be implemented by firmware stored in a ROM (read-only memory), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Given above is a description of the present disclosure based on the embodiment. The embodiment is intended to be illustrative only and it will be understood by those skilled in the art that various modifications to combinations of constituting elements and processes are possible and that such modifications are also within the scope of the present disclosure.

What is claimed is:

1. An image classification apparatus adapted to classify an input image, comprising:
an image classification model that calculates a prediction vector predicting a class into which the input image is classified;
a confidence level evaluation unit that calculates a probability vector and a confidence level of classification, based on the prediction vector for the input image;
an image conversion unit that converts the input image to generate a converted image when the confidence level is less than a first threshold value;
an integrated evaluation unit that calculates an integrated prediction vector derived from adding up the prediction vector for the input image and a prediction vector for the converted image calculated based on the image classification model and calculates an integrated probability vector from the integrated prediction vector; and
a classification determination unit that determines a class of the input image based on the probability vector or the integrated probability vector.

2. The image classification apparatus according to claim 1,
wherein it is ensured that the higher the confidence level, the smaller the number of converted images generated, and the lower the confidence level, the larger the number of converted images.

3. The image classification apparatus according to claim 1,
wherein, when the confidence level is less than a second reference value smaller than the first reference value, the converted image is not generated, or it is ensured that the lower the confidence level, the smaller the number of converted images generated.

4. An image classification method adapted to classify an input image, comprising:
calculating, by using an image classification model, a prediction vector predicting a class into which the input image is classified;
calculating a probability vector and a confidence level of classification, based on the prediction vector for the input image;
converting the input image to generate a converted image when the confidence level is less than a first threshold value;
calculating an integrated prediction vector derived from adding up the prediction vector for the input image and a prediction vector for the converted image calculated based on the image classification model, and calculating an integrated probability vector from the integrated prediction vector; and
determining a class of the input image based on the probability vector or the integrated probability vector.

5. A computer-readable non-transitory recording medium storing an image classification program adapted to classify an input image, comprising computer-implemented modules including:
a module that calculates, by using an image classification model, a prediction vector predicting a class into which the input image is classified;
a module that calculates a probability vector and a confidence level of classification, based on the prediction vector for the input image;
a module that converts the input image to generate a converted image when the confidence level is less than a first threshold value;
a module that calculates an integrated prediction vector derived from adding up the prediction vector for the input image and a prediction vector for the converted image calculated based on the image classification model and calculates an integrated probability vector from the integrated prediction vector; and
a module that determines a class of the input image based on the probability vector or the integrated probability vector.
